(19) United States
(12) Patent Application Publication
(10) Pub. No.: US 2013/0175763 A1
(43) Pub. Date: Jul. 11, 2013

(54) Lubricated Shaft Seal

(71) Applicants: Alexander Berdichevsky, Farmington Hills, MI (US); David Sakata, Livonia, MI (US); Sean Donovan, Howell, MI (US)

(72) Inventors: Alexander Berdichevsky, Farmington Hills, MI (US); David Sakata, Livonia, MI (US); Sean Donovan, Howell, MI (US)

(73) Assignee: FREUDENBERG-NOK GENERAL PARTNERSHIP, Plymouth, MI (US)

(21) Appl. No.: 13/346,775

(22) Filed: Jan. 10, 2012

(51) Int. Cl. F16J 15/32

(52) U.S. Cl. 277/552; 277/559

(57) ABSTRACT

A seal for sealingly engaging a shaft or other rotatable element includes a sealing portion having a lubricant side and a non-lubricant side and extending generally inwardly toward the shaft when the seal is installed thereon. The sealing portion has an active lip portion including a shaft engagement surface engageable with the shaft and a lubricant vent extending through at least a portion of the active lip portion. The lubricant vent provides fluid communication between opposite sides of the active lip portion, thus maintaining adequate lubrication between the shaft engagement surface and the shaft, avoiding lubricant coking, or other degradation, and extending seal life.

### FIELD

This disclosure relates generally to seals for shafts or other rotatable members or elements.

### BACKGROUND

Shaft seals are used in various types of machinery and equipment in the automobile industry, as well as in many other industries, for sealingly engaging a rotatable or slidable shaft. Such seals typically have a non-lubricant (air or other atmosphere) side and a lubricant (e.g., oil) side and one or more sealing lips that engage the shaft and tend to keep the lubricant from leaking from the lubricant side to the non-lubricant side (whether the shaft is rotating, sliding, or stationary). Various seal shapes, configurations, and arrangements have been devised to accomplish this and to divert lubricant back to the non-lubricant side of the seal.

One type of such a seal arrangement includes one or more spiral grooves recessed into the sealing lip or alternately formed between spaced-apart ribs protruding in a generally radial inward direction from the lip (both arrangements hereinafter collectively referred to as “grooves”). These grooves are disposed on the active shaft-engaging surface of the sealing lip and serve to capture the migrated (or “leaked”) lubricant and hydrodynamically pump it back to the lubricant side as a result of the relative rotation between the seal and the shaft about which the seal is disposed. Such grooves have frequently been open to the lubricant side of the seal, thus providing fluid communication with the lubricant thereon. In some applications, however, such an open-groove arrangement can sometimes create the potential for static lubricant leaks when the shaft is stationary or for air leaks during pressurization testing of the machinery on which the seal is being used.

To address these potential leaks, the groove or grooves in one exemplary shaft seal arrangement do not extend all the way to the seal lip's leading or free edge that faces or is oriented toward the lubricant side. Rather, the groove is interrupted short of the free edge by way of a static dam or band, for example, disposed between the groove or grooves and the sealing lip free edge. Any lubricant that migrates past the sealing lip edge on the lubricant side is captured in the grooves, and its fluid pressure grows until it reaches a value that exceeds the seal lip opening pressure. When the lip opens under the influence of this built-up fluid pressure, the lubricant is directed back toward the lubricant side due to relative rotation between the seal and the shaft on which the seal is disposed.

Lubricant then gradually migrates back between the sealing lip and the shaft again when the shaft is rotating or during static conditions when the shaft is not rotating. In some embodiments of this type of seal arrangement, the shape or configuration of the groove or grooves is such that an induction zone is formed by one portion of the grooves and a booster zone is formed by a different portion of the grooves adjacent the static dam. In such an arrangement, the fluid pressure grows relatively slowly in the induction zone and relatively quickly in the booster zone until the opening pressure is exceeded.

The use of a static band or dam in such seals thus advantageously avoids or at least minimizes static or dynamic leakage as well as reducing problems resulting from insufficient fluid flow (e.g., lubricant coking or carbonization, etc.). By maintaining some amount of lubricant in the groove or grooves in the sealing lip's active sealing surface prior to the static dam liftoff, seal lip lubrication is improved, thereby reducing wear and extending seal life. Although this type of shaft seal arrangement has performed well, the present disclosure seeks to provide even further improvements in seal lip lubrication and seal life in order to meet increasingly demanding shaft sealing applications.

Still other types of radial shaft seals are of a type having an elastomeric body bonded to a metal case in which the active shaft-engaging portion of the lip can be made of polytetrafluoroethylene (PTFE), or at least has a PTFE portion, or other materials. Such seal designs of this type can have their leading or free ends of the PTFE lip surface or lip portion facing either the air (atmosphere or non-lubricant) side or the lubricant side of the seal. In such designs where the free edge of the sealing lip faces the lubricant side, however, installation difficulties have sometimes been experienced, necessitating the use of special fixtures and special precautions so as not to nick or damage the surface of the PTFE material during assembly and destroy the functionality of the seals.

In response to such difficulties, radial shaft seals with PTFE shaft-engaging surfaces have been developed where the free end of the lip seal extends toward the air (non-lubricant) side of the seal rather than toward the lubricant side. Optionally, this type of seal can also have an oil side excluder lip seal, an air (non-lubricant) side dust excluder lip seal, and an elastomeric static seal extending from the elastomeric portion of the seal. This type of seal can be a one-piece sealing element, but can also advantageously be of a composite or “sandwiched” construction with a PTFE material for a primary shaft-engaging lip portion having grooves therein, as described above, and another elastomeric material for an elastomeric lip body to which the grooved shaft-engaging lip portion is preferably bonded. Examples can be found in U.S. Pat. No. 6,428,013, the entire disclosure of which is incorporated herein by reference.

Although all of the exemplary seal arrangements discussed above have been effective and have performed advantageously, the present disclosure seeks to further improve the seal's ability to retain lubricant between the sealing lip's active shaft-engaging surface and the shaft.

According to the present disclosure, a seal for a shaft or other rotatable member or element includes a sealing lip, an active lip surface oriented toward the lubricant side of the seal and having a shaft-engaging lip surface portion thereon, and a lubricant vent providing communication between the shaft engagement surface portion and the lubricant side. In some examples of seal arrangements according to the disclosure, such a lubricant vent can include an opening or orifice formed in a grooved (or even a non-grooved) sealing lip and providing substantially direct fluid communication between shaft-engaging lip surface and the lubricant side of the seal. Alternatively, in other seal arrangements, a channel extending through or along at least a portion of the lip can be used to provide fluid communication (either alone or in conjunction with an opening or orifice through the lip) between the shaft-engaging lip surface and the lubricant side of the seal. Such a channel configuration is especially advantageous in applications where the lip protrudes toward the air (non-lubricant) side of the seal and/or in applications where the sealing lip is of a composite or sandwiched construction, as mentioned above.

In one version of a lubricated seal according to the present disclosure the hydrodynamic pumping of lubricant tends to create a vacuum (or low pressure condition) after lift off of the seal lip free edge or static dam, which helps pull lubricant through the lubricant vent opening or to maintain an adequate supply of lubricant between the seal lip's shaft-engaging surface and the shaft as well as helping the shaft-engaging lip portion to maintain sealing contact with the shaft. This substantially minimizes lubricant coking and lubricant degradation, thus even further reducing wear and extending seal life, even in demanding high-temperature, high-speed applications.

Further advantages and additional areas of applicability of the present disclosure will become apparent from the detailed description provided hereinafter. It should be understood, however, that the detailed description and specific examples disclosed herein are intended for purposes of illustration only and are not intended to limit the scope of the disclosure.

### DRAWINGS

The drawings described herein are presented merely for illustration of selected example embodiments. They do not depict all possible implementations of the disclosure and are not intended to limit the scope of the present disclosure. Corresponding reference numerals indicate corresponding parts or elements throughout the several views of the drawings

FIG. 1 is a simplified perspective view of a seal according to the principles of the present disclosure;

FIG. 2 is a cross-sectional view of the seal of FIG. 1 disposed around a shaft;

FIG. 3 is an enlarged fragmented cross-sectional view of the active portion of the seal within the circle 3 of FIG. 2;

FIG. 4 is a graph of the hypothetical lubricant pressure in the groove as a function of distance for the seal configuration shown in FIG. 3;

FIGS. 5A through 5G are fragmented representations of various alternate cross-sectional configurations or geometry for the grooves used in the seal according to the principles of the present disclosure;

FIG. 6 is another alternate embodiment of the seal of FIG. 1 showing a different groove configuration having a booster zone;

FIG. 7A is yet another alternate embodiment of the seal of FIG. 1 showing a groove configuration with no booster zone;

FIG. 7B is yet another alternate embodiment of the seal of FIG. 1 showing a groove configuration with no static dam or band;

FIG. 7C is yet another alternate embodiment of the seal of FIG. 1 showing a groove configuration with a mid-lip static dam or band;

FIG. 8 is a simplified schematic representation of the active surface of the seal of FIG. 1, showing more than one distinct groove extending along the active surface of the seal;

FIG. 9 is an enlarged fragmented cross-sectional view of another example of a seal according to the present disclosure in which a lubricant vent channel extends through a composite seal lip to provide fluid communication with the lubricant side of the seal.

FIG. 10 is an enlarged fragmented cross-sectional view of the example seal of FIG. 9, illustrated as installed onto a shaft.

FIG. 11 is an enlarged fragmented cross-sectional view of another example of a seal according to the present disclosure having a one-piece, bifurcated, elastomeric seal lip in which a lubricant vent channel extends through the lip body portion of the seal lip to provide fluid communication with the lubricant side of the seal.

FIG. 12 is an enlarged fragmented cross-sectional view similar top that of FIG. 11, but showing a variation in which the lubricant vent channel and the opening are both in the shaft-engaging portion of the seal lip.

FIGS. 13A and 13B are enlarged fragmented cross-sectional view of still other alternate examples of seals according to the present disclosure, in which lubricant vent channels are formed by the space between spaced-apart primary lip portions and secondary lip portions to provide fluid communication with the lubricant side of the seal by way of lubricant vent openings through either the secondary lip portion (FIG. 13A) or the primary lip portion (FIG. 13B), respectively.

FIG. 14 is an enlarged fragmented cross-sectional view illustrating a shaft seal having no hydrodynamic pumping grooves in the active shaft-engaging portion of the sealing lip.

FIGS. 15 and 16 illustrate still other alternate examples of seals according to the present disclosure, in which hydrodynamic pumping grooves are formed between seal lips and radially-extending members that are fixed to their respective shafts for rotation therewith, with lubricant vent openings extending through the respective seal lip portions that sealingly engage the radially-extending members.

### DETAILED DESCRIPTION

Example embodiments will now be described more fully with reference to the accompanying drawings. Such example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that some specific details need not be employed, that example embodiments may be embodied in many different alternate forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element's or feature's relationship to another element(s) or feature(s) as illustrated in the figures. Such spatially relative terms may also encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass an orientation of above or below, depending upon a device's depicted orientation in the drawings. The device may be otherwise oriented (rotated 90 degrees or at other orientations) and the spatially relative descriptors used herein interpreted accordingly.

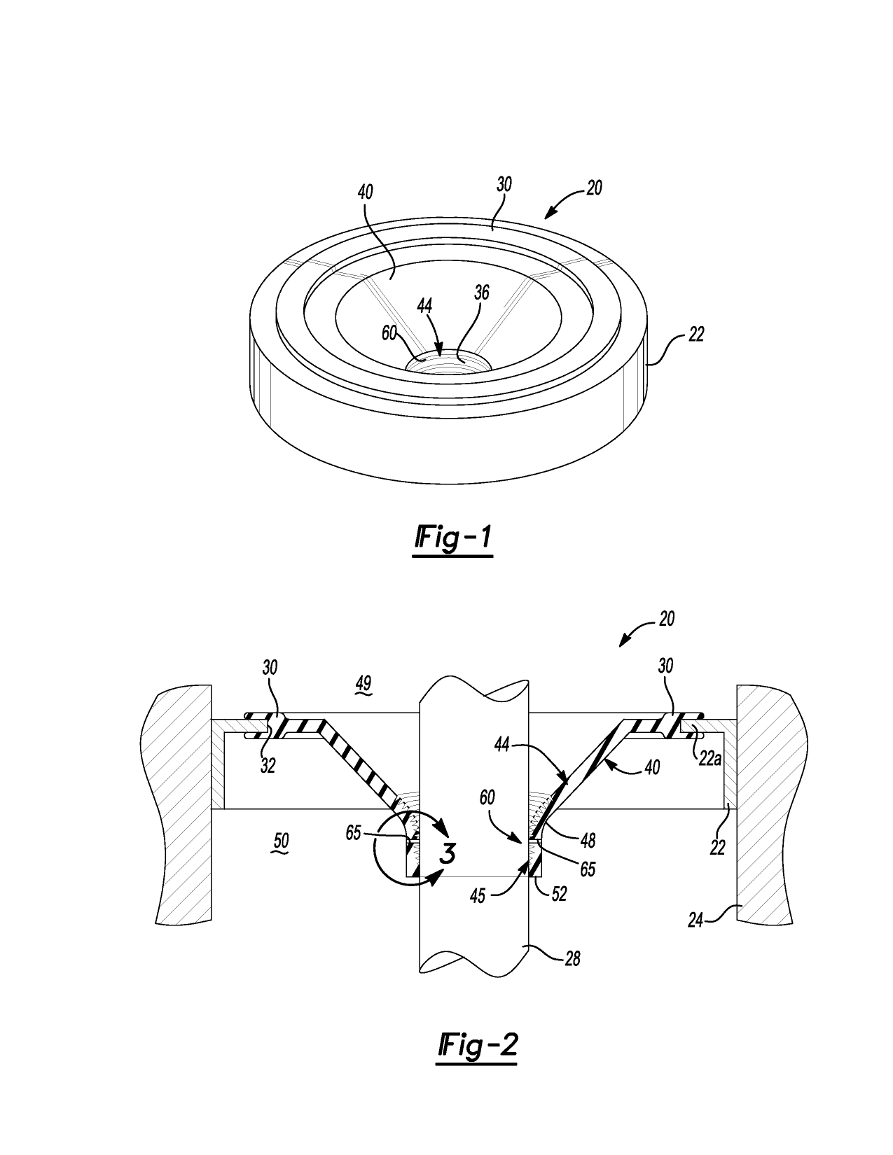

With reference to FIGS. 1 through 3, one example of a dynamic seal 20 according to the present disclosure is shown in a representative configuration. The seal 20 is mounted to a casing 22 which is disposed in a fixed housing 24 (best shown in FIG. 2) in a manner well known in the art. The seal 20 engages a rotary shaft 28 and provides a sealed relationship between the rotary shaft 28 and the housing 24 in which the casing 22 is disposed. With reference to FIG. 2, seal 20 can include a mounting portion 30 having an annular recess 32 for receiving a casing mounting portion 22a. It should be noted that the mounting portion 30 and the casing 22 can take on many well-known shapes and forms and are not considered to be particularly relevant to the seal design. The casing 22 can be made of plastic, metal, or other suitable materials, and the mounting portion 30 can be bonded, molded, or otherwise affixed thereto according to well-known techniques.

The seal 20 includes a central opening 36 through which the shaft 28 is disposed. The diameter of opening 36 is dimensioned to be less than the diameter of the shaft 28 to provide a fluid-tight seal therebetween as the portion of the seal 20 proximate the opening 36 deforms as the seal 20 is positioned on the shaft 28.

The seal 20 has a conically-shaped sealing lip 40 extending axially and radially toward the shaft 28. The sealing lip 40 has an active side or surface 44 with a seal-engaging surface portion 45 that engages the shaft 28, a non-active side or surface 48 that is opposite the active surface 44 and does not engage the shaft 28, and a free or leading seal lip edge 52. Part of the active surface 44 is exposed to the air (non-lubricant) side 49 while the non-active surface 48 and seal lip edge 52 are exposed to the lubricant side 50.

At least one groove 60 (two grooves are shown, for example, in FIG. 8) spirals circumferentially and axially along at least the shaft-engaging surface portion 45 of the active surface 44 and around shaft 28 with land portions 62 disposed therebetween. The spiral pitch of the groove 60 can be either constant or variable as is determined to be best suited for the application. The groove 60 can be coined, molded, cut into or otherwise formed along the active surface 44, or can alternately be formed between spiral ribs protruding from the active surface 44 and forming the land portions 62.

Due to the relative rotation between the shaft-engaging surface portion 45 of the active surface 44 and the shaft 28, the groove 60 captures lubricant that seeps or migrates past the seal lip edge 52 and hydrodynamically pumps it past the seal lip edge 52 back to the lubricant side 50.

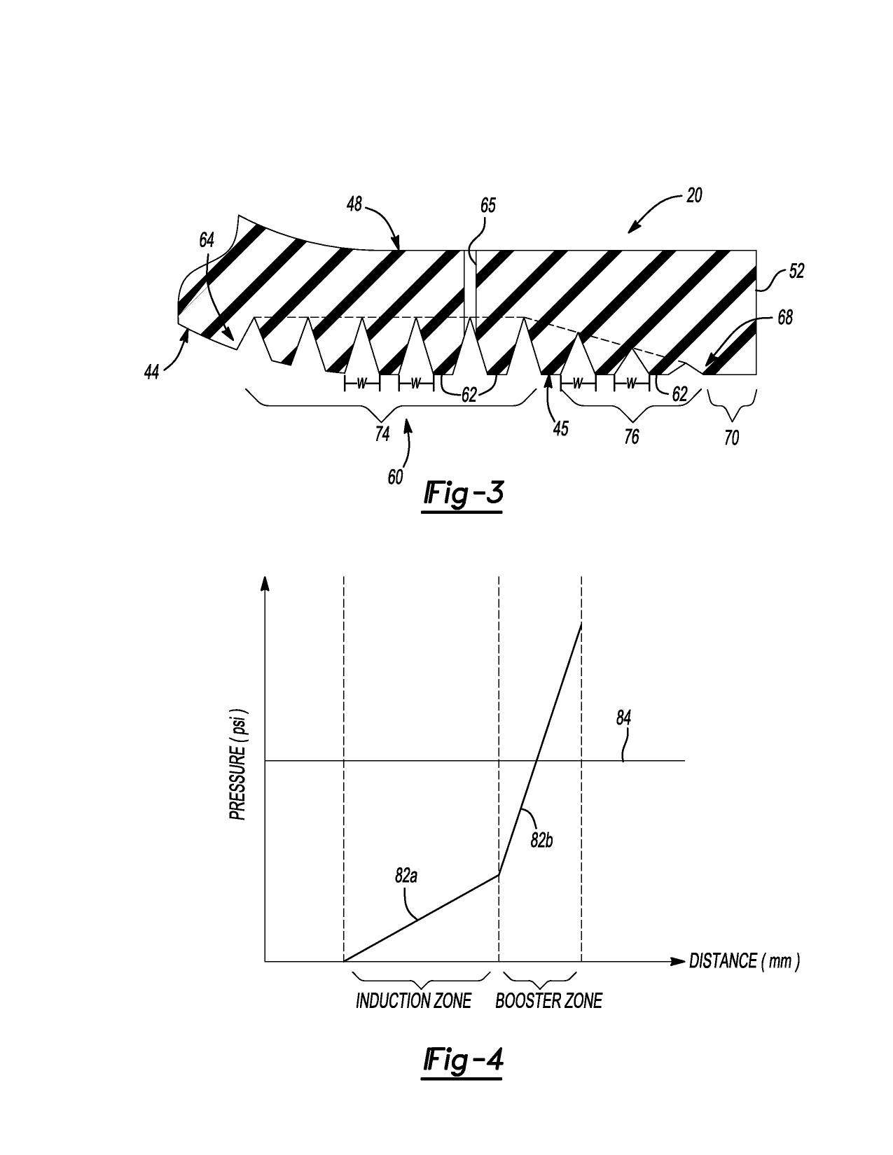

The groove 60 can be a single groove that extends helically or spirally along the active surface 44 between a beginning point 64 and a termination point 68, as shown in FIG. 3. Alternatively, as shown in FIG. 8, the seal 20 can have multiple grooves that extend helically or spirally along the active surface 44, with a first groove 60a extending from a beginning point 64a to a termination point 68a while a second groove 60b extends from a beginning point 64b to a termination point 68b. In the example shown in the drawings, the grooves 60a and 60b do not intersect one another and spiral along the active surface 44 in the same direction. The direction in which the grooves 60 or the 60a and 60b spiral determines the direction in which captured lubricant is routed due to relative rotation between the seal 20 and the shaft 28. While seal 20 is shown in the various Figures as having either one or two grooves 60 (or 60a and 60b), it should be appreciated that more than two grooves can be provided along the active seal-engaging surface 44.

The groove 60 stops short of reaching the seal lip edge 52 and is interrupted by a static band or dam 70 disposed between the seal lip edge 52 and the termination point 68. The static dam 70 is preferably disposed adjacent the seal lip edge 52 and is in direct sealing contact with the shaft 28. To further facilitate the hydrodynamic pumping of lubricant back to the lubricant side 50, the groove 60 can include two distinct regions 74 and 76. The first region 74 functions as an induction zone while the second region 76 functions as a booster zone. In the induction zone 74 shown for purposes of illustration, the groove 60 has a cross-sectional area that is substantially constant, although other uniform or non-uniform cross-sectional shapes can also be employed. In contrast, the booster zone 76 has a cross-sectional area that diminishes, ultimately decreasing to zero, as the groove 60 extends to the termination point 68 adjacent the static dam 70. In one embodiment, the width W of the groove 60 in both the induction zone 74 and the booster zone 76 can be the same while the depth of the groove 60 in the induction zone 74 is different from the depth of the groove 60 in the booster zone 76. Specifically, in the induction zone 74 the depth of the groove 60 is substantially constant, while in the booster zone 76 the depth of the groove 60 diminishes as the groove 60 approaches the termination point 68. Thus, the cross-sectional area of the groove 60 in the induction zone 74 is substantially constant while the cross-sectional area of the groove 60 in the booster zone 76 approaches zero as the groove 60 approaches the termination point 68. This diminishing cross-sectional area of the groove 60 in the booster zone 76 advantageously facilitates the return of lubricant from the groove 60 back to the lubricant side 50, as described below.

Referring now to FIG. 4, a hypothetical example of the fluid pressure within the groove 60 as a function of the location within the groove 60 is shown. As lubricant is captured by the groove 60, the relative rotation between the seal 20 and the shaft 28 pumps the lubricant toward the termination point 68. As a result, the fluid pressure within the groove 60 increases as the termination point 68 is approached. In the illustrative groove shown in the drawings, the fluid pressure growth (curve 82a) in the induction zone 74 is at a lower and increases at a slower rate than does the fluid pressure growth (curve 82b) within the booster zone 76. This is due to the substantially uniform cross-sectional area of the groove 60 in the induction zone 74, in which the fluid pressure grows at a relatively slow rate which may or may not be a constant rate. When the lubricant enters into the booster zone 76, however, the diminishing cross-sectional area of the groove 60 causes the fluid pressure to increase more rapidly as the groove 60 approaches termination point 68. This increased rate of fluid pressure growth in the booster zone 76 may be a constant or non-constant rate, depending upon the size, shape or other configurations of the groove 60.

In operation, the fluid pressure within the groove 60 thus continues to grow until a critical value, i.e., the opening pressure of the seal lip edge 52 and the static dam 70 (represented by line 84 in FIG. 4) is met or exceeded. As soon as the built-up fluid pressure in the booster zone 76 meets or exceeds this critical value, the seal lip edge 52 and the static dam 70 open or lift off the shaft 68 and the lubricant is allowed to flow back to the lubricant side 50. Once the fluid pressure within the groove 60 drops below this critical pressure, the seal lip edge 52 and the static dam 70 move back into sealing engagement with the shaft 28 and the flow of lubricant from the groove 60 to the lubricant side 50 ceases. The lubricant will again begin to collect within the groove 60 and cause the fluid pressure therein to increase. Once the fluid pressure again exceeds the critical value, the static dam 70 will separate from the shaft 28 and allow the lubricant within the groove 60 to again flow into lubricant side 50.

The physical shape and dimensions of the groove 60 are chosen to provide a pumping rate that is equal to or greater than the expected leakage rate of lubricant past the seal lip 52 for the expected life of the seal 20, taking into account the expected increase in this leakage rate due to seal wear or other factors over the life of the seal.

In order to further improve the life and performance of the seal 20, the seal lip 40 is provided with one or preferably a number of lubricant vents 65 in the form of openings or orifices through the sealing lip 40 at the shaft-engaging surface portion 45 of the active surface 44. Six of such lubricant vents 65 are shown for example in FIG. 8 as being uniformly spaced circumferentially. Alternately, however, other numbers of the lubricant vents 65 can also be provided at other uniform or non-uniform circumferential positions. It should also be pointed out that although the example of FIGS. 1 through 4 shows the lubricant vents 65 being located in the induction zone 74, lubricant vents 65 can also (or in the alternative) be located in the booster zone 76.

The provision of one or more lubricant vents 65 at the shaft-engagement portion 45 of the seal 20 allows the seal 20 to meet ever-increasing demands for longer durability and higher shaft speeds in the marketplace. In the dynamic state described above, the hydrodynamic pumping of the first sealing element will create a vacuum between the sealing engaging portion 45 and the shaft 28. This vacuum will help pull lubricant through the lubricant vents 65 as well as help the seal-engaging surface portion 45 to maintain contact with the shaft 28. This flow of lubricant through the lubricant vents 65 helps to assure lubrication and cooling of the seal-engaging surface portion 45 in order to further avoid and minimize lubricant degradation and carbonization in the pumping region in contact with the shaft, as well as reducing sealing lip temperatures. All of these improvements contribute to extended durability and life of the seal 20.

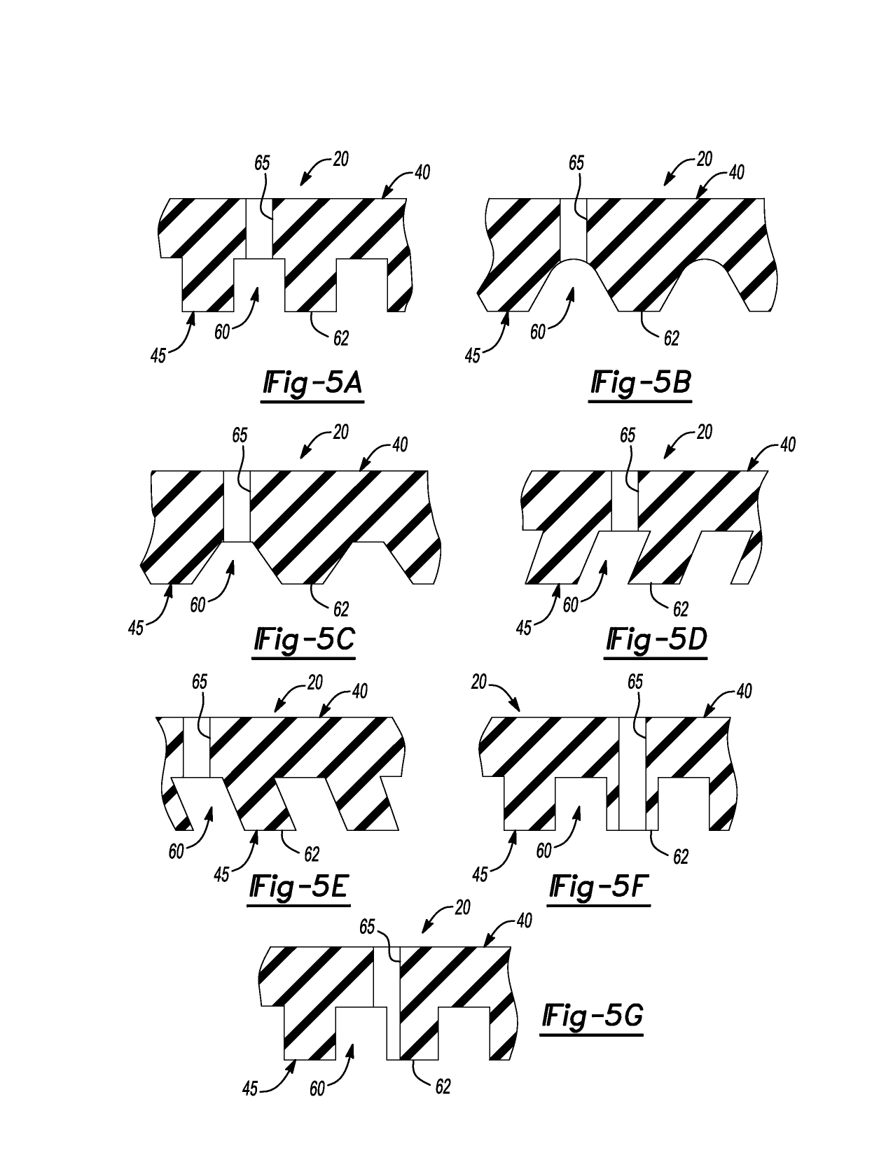

As shown in FIGS. 5A through 5G, other groove geometries and cross-sectional shapes, as well as alternate lubricant vent locations, can be employed. For example, the cross-sectional shape of the groove or grooves 60 can be square or rectangular, as shown in FIG. 5A, curved or rounded, as shown in FIG. 5B, trapezoidal, as shown in FIG. 5C, and/or skewed toward or away from seal lip edge 52, as shown in FIGS. 5D and 5E, respectively. It should be appreciated that, while it is preferred to keep the cross-sectional area of the grooves 60 substantially constant in the induction zone 74, the geometry of the grooves 60 can change while maintaining the cross-sectional area substantially constant and thus still achieve a gradual buildup of fluid pressure within the induction zone 74. The geometry of the grooves 60 can also change in the booster zone 76 so long as the above-discussed groove cross-sectional area reduction occurs and approaches zero at the respective termination points 68, 68a, or 68b.

FIGS. 5F and 5G illustrate alternate positioning of the lubrication vent 65. In the example embodiments shown for purposes of illustration in FIGS. 5A through 5E, the lubrication vent 65 extends through the sealing lip 40 at a position within the groove 60 and between the lands 62 in embodiments having different groove cross-sectional shapes. The lubrication vents 65 can also extend through the sealing lip 40 at the land portions 62 (FIG. 5F) or even overlapping the land portions 62 and the grooves 60 (FIG. 5G) with any groove cross-sectional shape, including any of the examples shown FIGS. 5A through 5E.

Referring now to FIG. 6, another example embodiment of a seal 120 according to the principles of the present disclosure is shown. In the seal 120, the decreasing cross-sectional area of the booster zone 176 is different than that of the previous embodiments. Specifically, the depth D of the groove or grooves 160 in both the induction zone 174 and the booster zone 176 remains substantially constant. To decrease the cross-sectional area of the groove 160 within the booster zone 176, the width of the groove 160 at the seal-engaging surface 145 of the active surface 144 decreases as the groove 160 approaches the termination point 168.

The decreasing cross-sectional area of the groove 160 in the booster zone 176 causes the fluid pressure of the lubricant flowing through the lubricant vent 165 into the groove region between the seal-engaging surface 145 and the shaft (not shown in FIG. 6) to increase rapidly in the booster zone 176, allowing for operation of the seal 120 as discussed above. It should be appreciated that the manner in which the cross-sectional areas of groove or grooves 60 or 160 are decreased within the respective booster zones 76 or 176 can vary from that shown in the various example embodiments illustrated in the drawings. For example, a combination of a decreasing depth and a decreasing width of a groove 60 or 160 can be employed to reduce the cross-sectional groove area in the booster zone 176 as the groove 60 or 160 approaches the respective termination point 68, 68a, 68b, or 168.

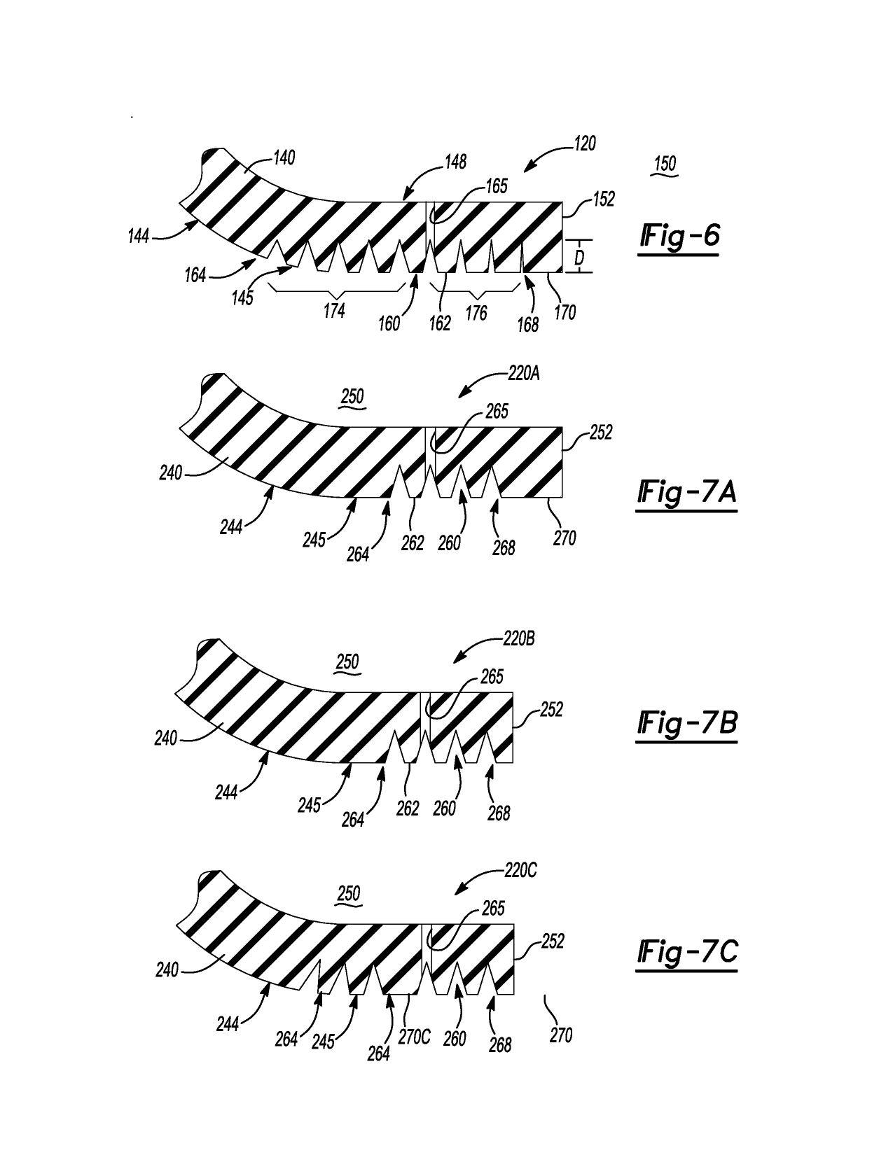

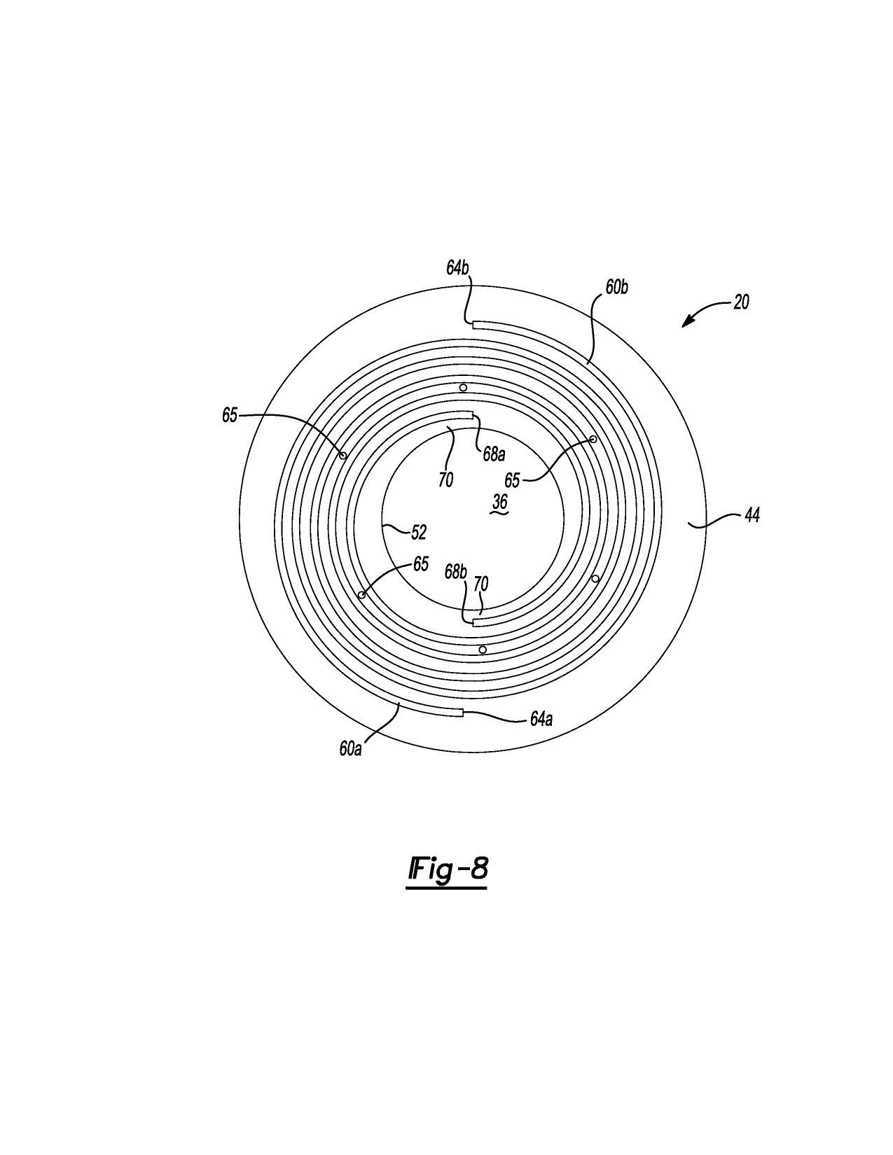

Referring now to FIG. 7A, another exemplary alternate embodiment of a seal 220A according to the principles of the present disclosure is shown. In this embodiment, a booster zone is not present. Rather, the groove 260 ends at the termination point 268 with the static dam 270 disposed between the termination point 268 and the free end or seal lip edge 252. Because the cross-sectional area of the groove 260 is generally uniform throughout its length, the fluid pressure of the lubricant flowing through the lubricant vent 265 into the groove region between the seal-engaging surface 245 and the shaft (not shown in FIG. 7) builds at a more gradual pace until eventually overcoming the critical pressure (the opening pressure of the static dam 270 at the seal lip edge 252) and directs the captured lubricant back to the lubricant side 250.

Referring to FIG. 7B, yet another exemplary alternate embodiment of a seal 220B according to the principles of the present disclosure is shown. In this embodiment, the seal 220B is similar to the seal 220A of FIG. 7A, except the seal 220B is adapted for applications where no static dam or band is needed.

Referring another to still another exemplary alternate embodiment, the seal 220C of FIG. 7C is similar to the seals 220A and 220B of FIGS. 7A and 7B, respectively, except for a mid-lip static dam or band 270C that interrupts the spiral groove 260 at a medial location on the seal-engaging surface 245. The mid-lip static dam or band 270C can be in contact with the shaft (not shown in FIGS. 7A through 7C) and functions primarily as a static seal when the shaft is not rotating or otherwise moving. It should be noted that the static dam 270C can alternatively be spaced very slightly away from the shaft, in which case the lubricant's surface tension between the static dam 270C and the shaft creates or at least contributes to the static sealing.

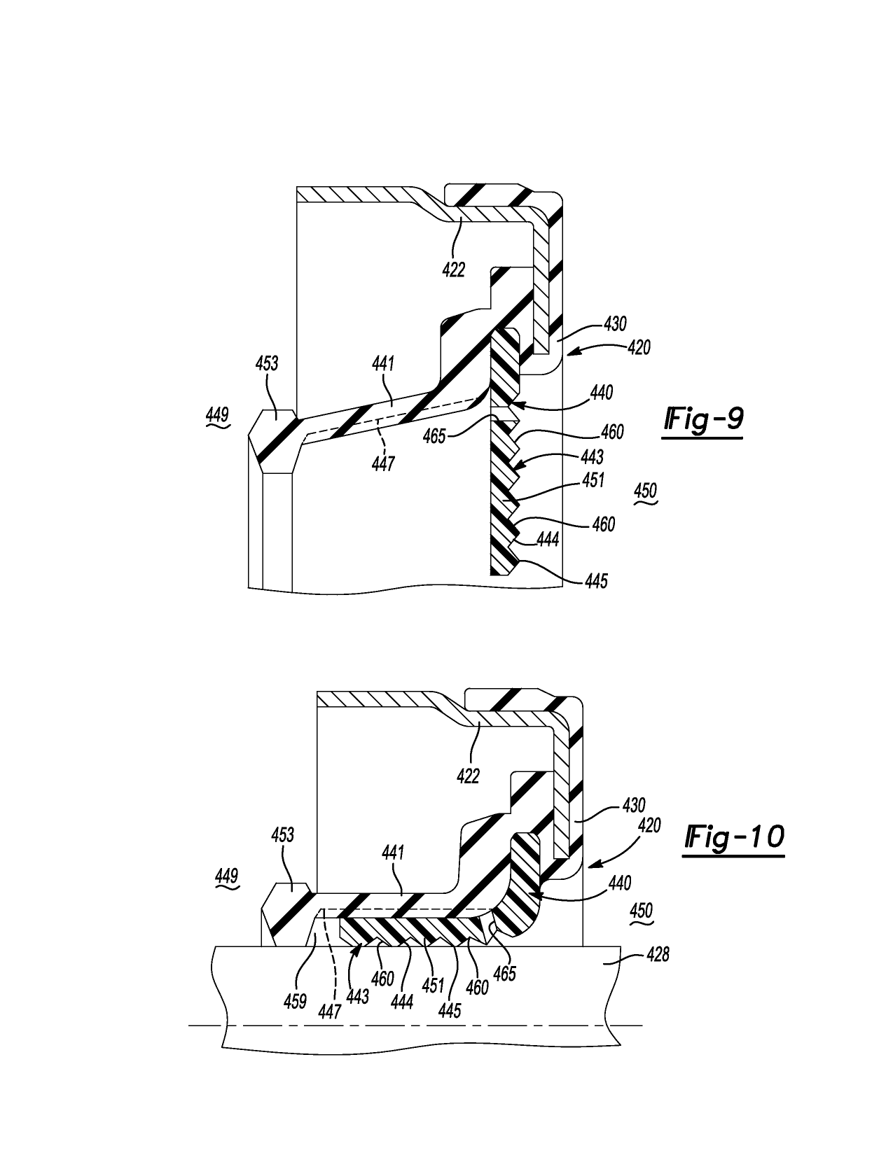

FIGS. 9 and 10 illustrate another example of a seal 420 including a casing 422, a mounting portion 430, and a seal lip 440 for sealing against a shaft 428. The seal lip 440 extends toward the air (non-lubricant) side 449 and is of a composite or sandwiched construction including a lubricant vent channel 447 extending between a preferably elastomeric lip body portion or layer 441 and a preferably PTFE primary lip portion or layer 451 with a lubrication vent opening 465 therethrough. A secondary static dam or secondary lip portion 453 at the free end of the lip body portion 441 seals against the shaft under static conditions.

In order to obtain the lubrication benefits and advantages discussed above in connection with other examples of seals according to the disclosure, the lubricant between the shaft 428 and the grooves 460 in the active shaft-engaging surface 444 is pumped under dynamic conditions through a gap 459 at the end of primary lip portion 451, through the lubricant vent channel 447, through the lubrication vent opening 465, and back to the lubricant side 450 of the seal 420. This also tends to create a vacuum in the gap 459 to help the secondary lip portion 453 maintain contact with the shaft under dynamic conditions.

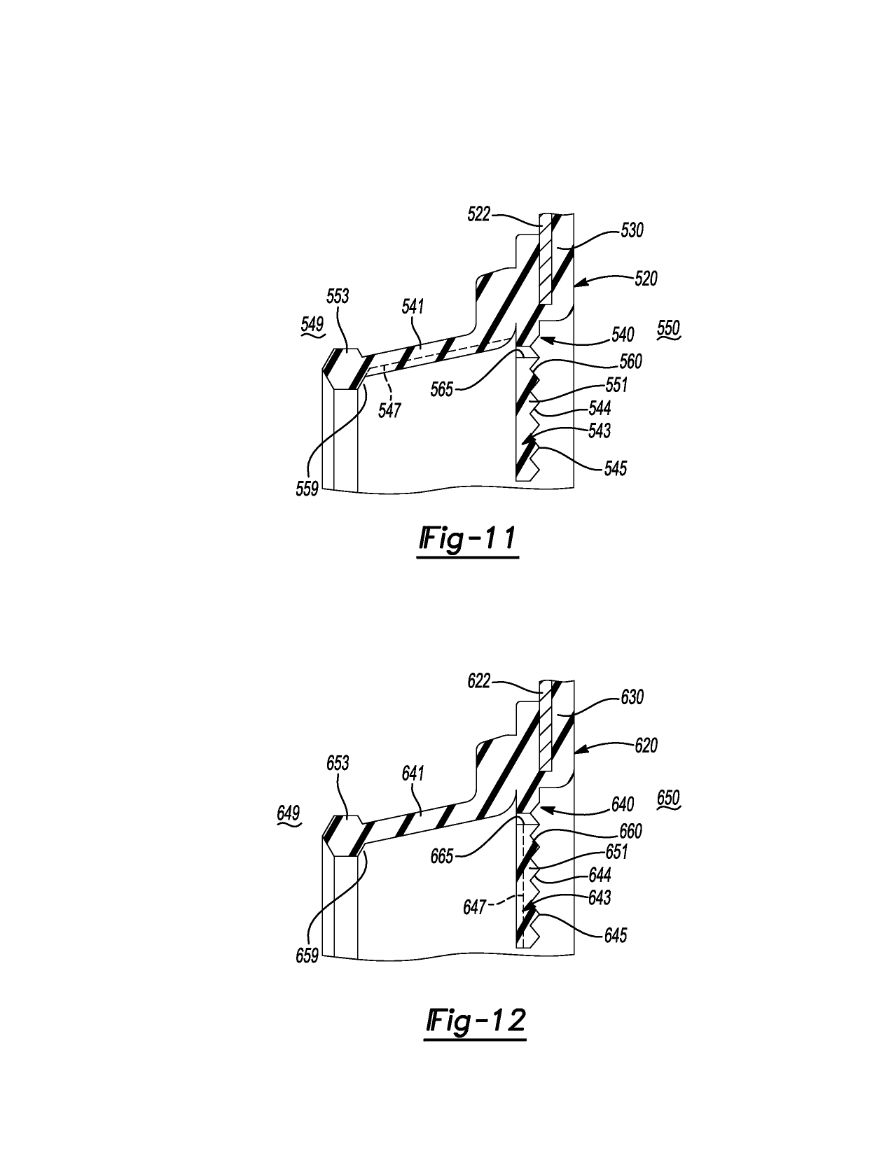

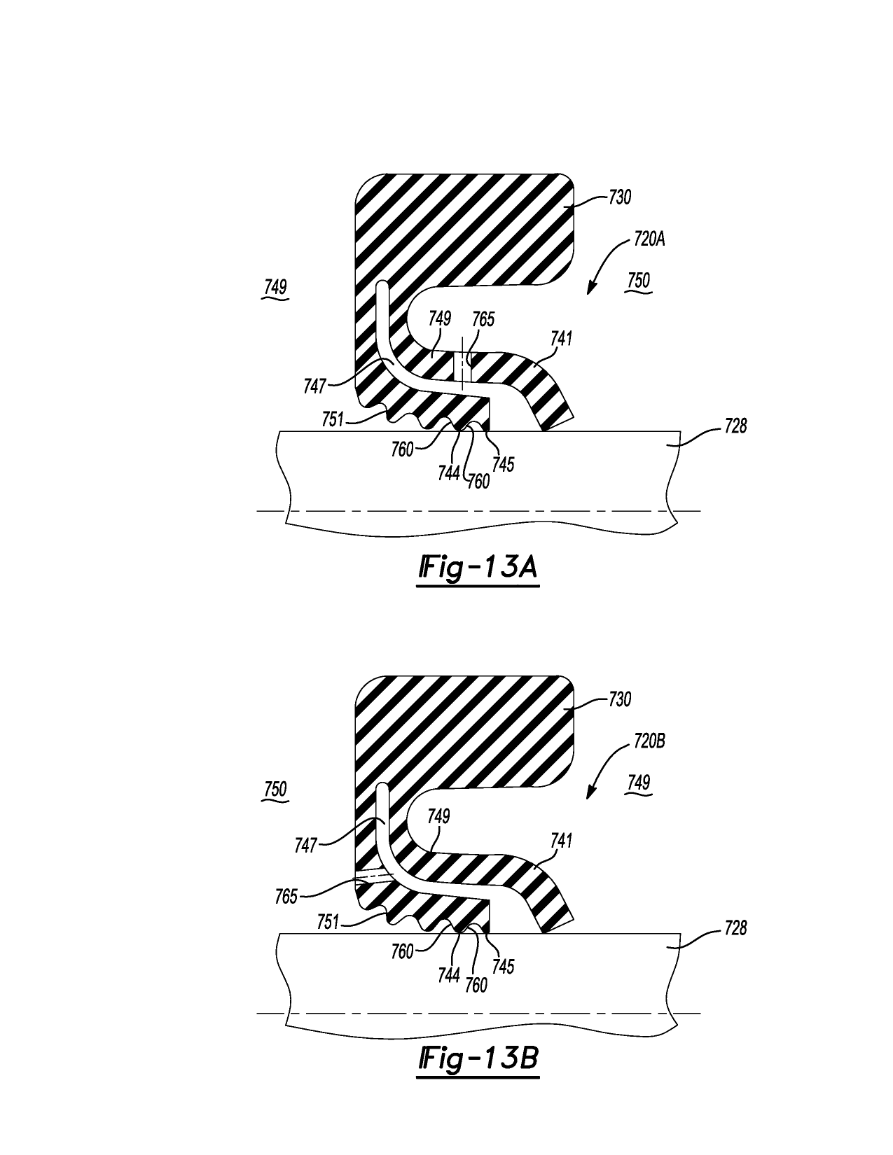

FIGS. 11 and 12 depict example seal arrangements similar to that of FIGS. 9 and 10, but with further variations. As such, the elements indicated by reference numerals having five-hundred and six hundred prefixes, respectively, in FIGS. 11 and 12, correspond in general function with similar elements of FIGS. 9 and 10 that are indicated by reference numerals having four-hundred prefixes.

In FIG. 11, the composite, sandwiched construction of the primary PTFE lip portion or layer 451 and the elastomeric lip portion or layer 441 of FIGS. 9 and 10 is replaced by a one-piece, bifurcated sealing lip arrangement 540 having a primary lip portion or layer 551 and a secondary lip portion or layer 541, with the lubricant vent channel 547 extending therebetween along the secondary lip portion 541 to provide communication by way of the lubricant vent opening 565 with the lubricant side 550 of the seal 520. In FIG. 12, however, the lubricant vent channel 647 is on the primary lip portion 651 rather than on the secondary lip portion 641. Lubricant flow is thus provided by way of fluid communication from the area between the shaft-engaging sealing surface 645 and the shaft, through the gap 659, through the lubricant vent channel 647, through the lubricant vent opening 665, and back to the lubricant side 650 of the seal 620.

FIGS. 13A and 13B illustrate two example of alternate variations of a seal 720 according to the present disclosure, in which a primary sealing lip portion 751 and a secondary lip portion 741 both face toward the lubricant side 750 in FIG. 13A or toward the non-lubricant side 749 in FIG. 13B and are spaced apart to form lubricant vent channels 747 therebetween. The lubricant vent channels provide fluid communication with the lubricant side of the seal 720 by way of lubricant vent openings through either the secondary lip portion 741 (FIG. 13A) or the primary lip portion 751 (FIG. 13B), respectively, in a manner similar to that described above in connection with other examples of the present disclosure.

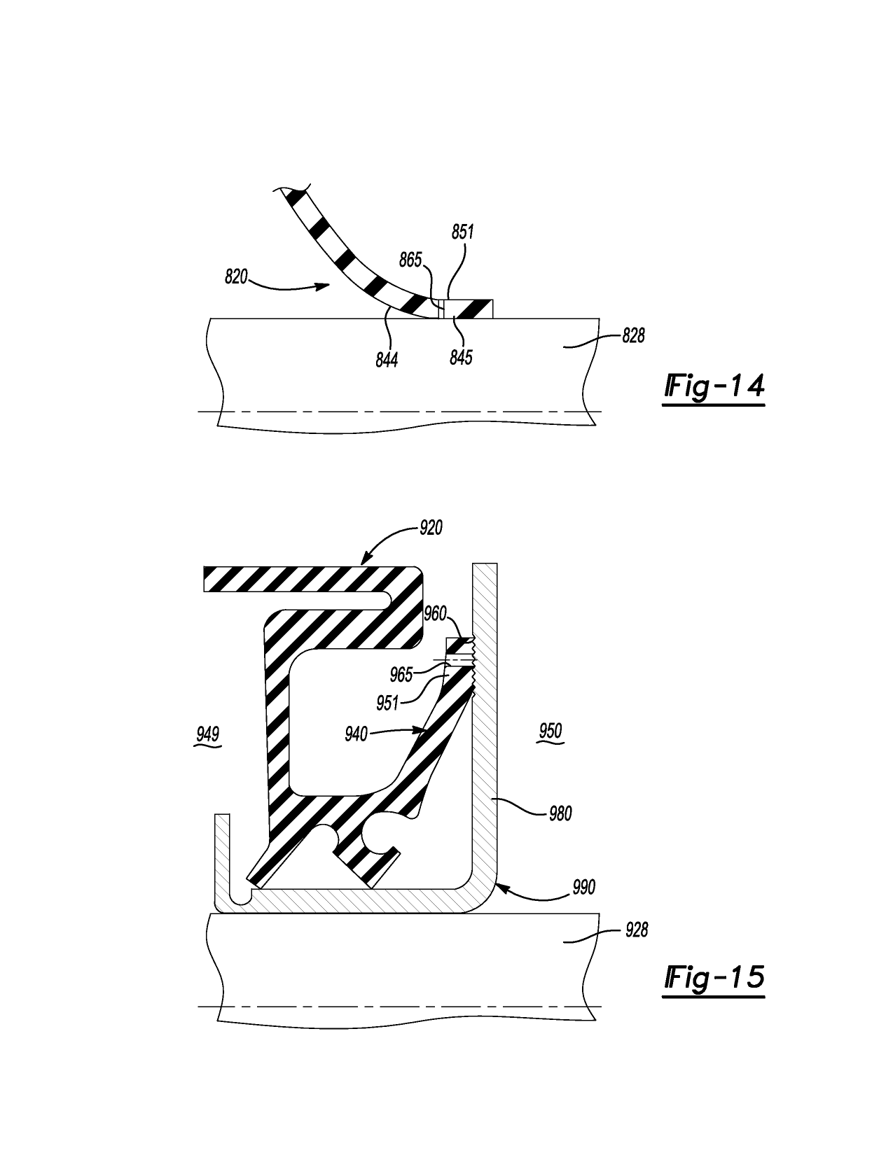

FIG. 14 shows a seal 820 having a sealing lip portion 851 with a lubricant vent 865 extending therethrough to provide lubricant venting and fluid communication as discussed above in connection with other examples of other seals according to the present disclosure. Although the above-described hydrodynamic grooves provide distinct benefits and improvements, the principles of the present disclosure can also be advantageously employed in seals having no grooves on the shaft-engaging surface 845 of the lip portion 851 (illustrated schematically in FIG. 14) as well as on alternate groove-less shaft-engaging surfaces on any of sealing the lip portions shown in the drawings or discussed herein.

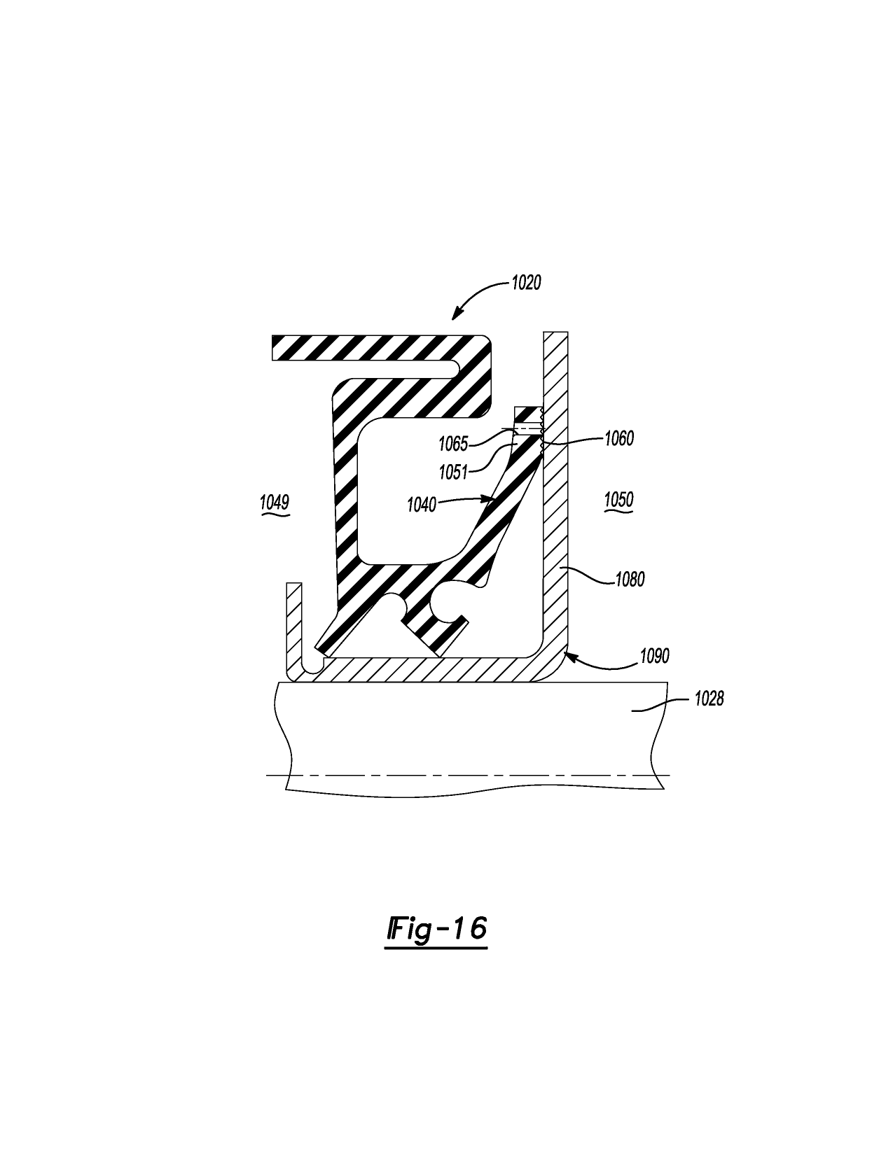

FIGS. 15 and 16 illustrate two exemplary versions of still another alternate example seal configuration according to the disclosure. In FIG. 15, a seal 920 with a sealing lip 940 according to the present disclosure is shown. In FIG. 15, a hydrodynamic pumping groove (or grooves, as explained above) 960 is formed in a flange portion 980 of a rotatable member 990 that is fixed to the shaft 928 for rotation therewith. A lubricant vent opening 965 extends through a seal lip portion 951 having a flange-engaging portion that sealingly engages the flange 980. The lubricant vent opening 965 provides fluid communication for lubricant in the hydrodynamic groove 960 between the seal lip portion 951 and the flange portion 980 (by way of the rotating interaction therebetween) in order to return the lubricant to the lubricant side 950 of the seal 920. The flange portion 980 can extend in a generally radial or other transverse direction relative to the centerline of the shaft. Either or both of the rotatable member 990 and its flange portion 980 can be formed of any of a number of metal, plastic, or elastomeric materials, natural or synthetic, suitable for the particular application and environment.

Another version of an exemplary seal configuration somewhat similar to that of FIG. 15 is shown in FIG. 16. In FIG. 16, however, the hydrodynamic groove (or grooves) 1060 is formed in the seal lip portion 1051 (rather than in the rotatable flange portion 980 of FIG. 15), with the lubricant vent opening 1065 extending through the seal lip portion 1051. In this example, the flange 1080 preferably has no hydrodynamic groove formed therein.

While the present disclosure has been described and illustrated with reference to specific embodiment examples, it should be appreciated that these embodiments are merely illustrative and exemplary and that variations that depart from the embodiments shown are intended to be within the scope of the present disclosure. For example, while a variety of geometries are shown for the cross-sectional configuration of the groove or grooves, it should be appreciated that these cross-sectional geometries are merely exemplary and that other cross-sectional geometries can be employed. The shape of land portions of the active and shaft-engaging surfaces can vary, such as for example, with a width that varies and/or may be reduced to a generally “point” or “line” shape or configuration.

Additionally, while the seal has been shown with reference to various sealing lip, mounting portion and casing arrangements, it should be appreciated that these are merely exemplary and that other configurations that allow an active surface of a seal to engage with a shaft or other rotatable element or member can alternately be employed. Moreover, a seal according to the disclosure does not need to seal directly against the outer diameter of a shaft, but can alternately have a shaft-engaging surface portion that seals against a component attached to a shaft, such as a flat area or surface of an axial slinger or flange, with lubricant pumping in a generally radial direction. Furthermore, while the depiction of multiple grooves in FIG. 8 shows the termination and ending points for the respective grooves directly across from one another, it should be appreciated that they do not need to have such relative positioning and can be skewed from one another. Moreover, it should be appreciated that any dimensions shown or implied herein for a seal according to the disclosure are merely exemplary to facilitate an understanding of the principles and functionality of the present disclosure. As such, the dimensions shown herein can vary without deviating from the spirit and scope of the present disclosure.

Furthermore, as mentioned above, it should be appreciated that while the pumping element is described as grooves, the use of raised ribs on the active surface of the seal may also be utilized in lieu of the grooves although all of the benefits of the present disclosure may not be realized. Moreover, it should be appreciated that while the shaft is described as being a rotary shaft, it could be stationary and the seal or a component attached to it could rotate about the shaft.

Seals according to the principles of the disclosure, can be made from a variety of material compositions. For example, materials for the dynamic seal can include plastic, synthetic or natural rubber, or any of a wide variety of known elastomers, such as PTFE, TPE (thermoplastic elastomers), TPV (thermoplastic volcanizates), and FlouroXprene® material, a composition described in U.S. Pat. No. 6,806,306, among others. While particular materials of construction have been disclosed as being among those suitable for use in the seal, it should be appreciated that such a list is merely illustrative and not exhaustive of the types of materials that can be used to form a seal according to the principles of the present disclosure.

Thus, variations that do not depart from the gist of the disclosure are intended to be within the scope of the disclosure. Such variations are not to be regarded as a departure from the spirit and scope of the disclosure.

Further areas of applicability of the present disclosure will become apparent from the detailed description provided hereinafter. The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A shaft seal for sealingly engaging a shaft, comprising:
a mounting portion;
a sealing lip attached to said mounting portion and having an active lip portion with a lubricant side and a non-lubricant side, said active lip portion extending generally inwardly from said mounting portion toward the shaft when the shaft seal is installed thereon, said active lip portion including a shaft engagement surface engageable with the shaft; and
a lubricant vent extending through at least a portion of said active lip portion and providing fluid communication between said shaft engagement surface and the lubricant side.

2. A shaft seal according to claim 1, further including a groove formed in said shaft engagement surface for hydrodynamically conveying lubricant from an area between said shaft engagement surface and the shaft in a direction toward the lubricant side.

3. A shaft seal according to claim 2, wherein said groove is a continuous spiral groove extending across at least a portion of said shaft engagement surface.

4. A shaft seal according to claim 3, said spiral groove is interrupted by a static band generally adjacent the lubricant side.

5. A shaft seal according to claim 1, wherein at least a portion of said active lip portion includes a first lip body portion with said shaft engagement surface thereon, and a second lip primary portion on an opposite side of said active lip portion from said shaft engagement surface, said lubrication vent extending at least in part between said first lip body portion and said second lip primary portion.

6. A shaft seal according to claim 5, wherein one of said lip portions is composed of a polytetrafluoroethylene-containing material.

7. A shaft seal according to claim 1, wherein at least said active lip portion is composed of an elastomeric material.

8. A shaft seal according to claim 1, wherein at least said active lip portion is composed of an polytetrafluoroethylene-containing material.

9. A shaft seal according to claim 1, wherein the shaft is a rotatable shaft, said active lip portion extending generally radially inwardly from said mounting portion toward the shaft and toward the lubricant side when the shaft seal is installed thereon.

10. A shaft seal according to claim 1, wherein the shaft is a rotatable shaft, said active lip portion extending generally radially inwardly from said mounting portion toward the shaft and toward said non-lubricant side when the shaft seal is installed thereon.

11. A shaft seal mountable on a rotatable shaft to prevent the migration of lubricant fluid from a lubricant side to a non-lubricant side, said shaft seal comprising:
a case member;
a primary seal ring attached to said case member, said primary seal ring having an active lip portion mountable in sealing contact with the shaft, said an active lip portion having a shaft engagement surface thereon and at least one spirally-extending hydrodynamic groove in said shaft engagement surface; and
a lubrication vent extending through at least a portion of said primary seal ring and providing communication between said shaft engagement surface and the lubricant side.

12. A shaft seal according to claim 11, wherein said hydrodynamic groove increases in depth from said one end of said primary seal ring.

13. A shaft seal according to claim 11, wherein said hydrodynamic groove has non-parallel side walls on opposite sides thereof.

14. A shaft seal according to claim 11, wherein said hydrodynamic groove has parallel side walls on opposite sides thereof.

15. A shaft seal according to claim 11, wherein said hydrodynamic groove is generally uniform in depth.

16. A shaft seal according to claim 15, wherein said hydrodynamic groove has non-parallel side walls on opposite sides thereof.

17. A shaft seal according to claim 15, wherein said hydrodynamic groove has parallel side walls on opposite sides thereof.

18. A shaft seal according to claim 11, wherein said hydrodynamic groove has a varying depth throughout its extent.

19. A shaft seal according to claim 18, wherein said hydrodynamic groove has non-parallel side walls on opposite sides thereof.

20. A shaft seal according to claim 18, wherein said hydrodynamic groove has parallel side walls on opposite sides thereof.

21. A shaft seal according to claim 11, wherein said active lip portion extends generally radially inwardly from said mounting portion toward the shaft and toward the lubricant side when the shaft seal is installed thereon.

22. A shaft seal according to claim 11, wherein said active lip portion extends generally radially inwardly from said mounting portion toward the shaft and toward said non-lubricant side when the shaft seal is installed thereon.

23. A shaft seal mountable on a rotatable shaft to prevent the migration of fluid lubricant from a lubricant side to a non-lubricant side, said shaft seal comprising:
a case member;
a primary seal ring attached to said case member, said primary seal ring having an active lip portion mountable in sealing contact with the shaft, said active lip portion extending radially inwardly toward the lubricant side, said active lip portion having a shaft engagement surface engageable the shaft, said shaft engagement surface having a spiral groove extending toward the lubricant side to permit fluid accumulated in said spiral groove to move back toward the lubricant side, and a lubrication vent opening extending through at least a portion of said active lip portion and providing communication between said shaft engagement surface and the lubricant side.

24. A shaft seal according to claim 23, wherein at least a portion of said spiral groove decreases in depth toward the lubricant side.

25. A shaft seal according to claim 24, wherein said spiral groove has non-parallel side walls on opposite sides thereof.

26. A shaft seal according to claim 24, wherein said spiral groove has parallel side walls on opposite sides thereof.

27. A shaft seal according to claim 23, wherein said spiral groove is generally uniform in depth.

28. A shaft seal according to claim 27, wherein said spiral groove has non-parallel side walls on opposite sides thereof.

29. A shaft seal according to claim 27, wherein said spiral groove has parallel side walls on opposite sides thereof.

30. A shaft seal mountable on a rotatable shaft to prevent the migration of fluid lubricant from a lubricant side to a non-lubricant side, said shaft seal comprising:
a case member;
a primary seal ring attached to said case member, said primary seal ring having an active lip portion mountable in sealing contact with the shaft, said active lip portion extending radially inwardly toward the non-lubricant side, said active lip portion having a shaft engagement surface engageable the shaft, said shaft engagement surface having a spiral groove extending toward the lubricant side to permit fluid accumulated in said spiral groove to move back toward the lubricant side, and a lubrication vent opening extending through at least a portion of said active lip portion and providing communication between said shaft engagement surface and the lubricant side.

31. A shaft seal according to claim 30, wherein at least a portion of said spiral groove decreases in depth toward the lubricant side.

32. A shaft seal according to claim 31, wherein said spiral groove has non-parallel side walls on opposite sides thereof.

33. A shaft seal according to claim 31, wherein said spiral groove has parallel side walls on opposite sides thereof.

34. A shaft seal according to claim 30, wherein said spiral groove is generally uniform in depth.

35. A shaft seal according to claim 34, wherein said spiral groove has non-parallel side walls on opposite sides thereof.

36. A shaft seal according to claim 34, wherein said spiral groove has parallel side walls on opposite sides thereof.

37. A shaft seal according to claim 30, wherein at least a portion of said active lip portion includes a first lip body portion with said shaft engagement surface thereon, and a second lip primary portion on an opposite side of said active lip portion from said shaft engagement surface, said first lip body portion and said second lip primary portion engaging each other at least in part when said shaft seal is installed on the shaft, said lubrication vent extending at least in part between said first lip body portion and said second lip primary portion.

38. A shaft seal according to claim 37, wherein said lubrication vent includes a channel in said first lip body portion in fluid communication with an opening extending through said second lip primary portion.

39. A shaft seal according to claim 37, wherein said lubrication vent includes a channel in said second lip primary portion in fluid communication with an opening extending through said second lip primary portion.

40. A shaft seal for sealingly engaging a shaft, comprising:
a mounting portion;
a seal portion having a lubricant side and a non-lubricant side;
said seal portion including an active lip portion extending generally inwardly toward the shaft when the shaft seal is installed thereon, said active lip portion including an shaft engagement surface engageable with the shaft;
a secondary lip portion extending generally inwardly toward the shaft when the shaft seal is installed thereon, said secondary lip portion being disposed between said active lip portion and the lubricant side;
a sealing appendage extending generally inwardly toward the shaft when the shaft seal is installed thereon, said sealing appendage being disposed between said active lip portion and the non-lubricant side; and
a lubricant vent opening extending through at least a portion of said active lip portion and providing fluid communication between opposite sides thereof.

41. A shaft seal according to claim 40, further including a groove formed in said shaft engagement surface for hydrodynamically conveying lubricant from an area between said shaft engagement surface and the shaft in a direction toward said secondary lip portion.

42. A shaft seal according to claim 41, wherein said groove is a continuous spiral groove extending across at least a portion of said shaft engagement surface.

43. A seal for sealingly engaging a rotatable member, comprising:
a mounting portion;
a sealing lip attached to said mounting portion and having an active lip portion with a lubricant side and a non-lubricant side, said active lip portion extending generally toward said lubricant side when the seal is installed in engagement with said rotatable member, said active lip portion including an engagement surface engageable with the rotatable member; and
a lubricant vent extending through at least a portion of said active lip portion and providing fluid communication between said engagement surface and the lubricant side.

44. A seal according to claim 43, further including a groove formed in said engagement surface for hydrodynamically conveying lubricant from an area between said engagement surface and the rotatable member in a direction toward the lubricant side.

45. A seal according to claim 43, further including a groove formed in the rotatable member for hydrodynamically conveying lubricant from an area between said engagement surface and the rotatable member in a direction toward the lubricant side, said engagement surface engaging at least a portion of said groove when the seal is installed in engagement with said rotatable member.

46. A seal according to claim 43, wherein the rotatable member is a rotatable shaft.

47. A seal according to claim 43, wherein the rotatable member is a flange extending transverse to the centerline of a rotatable shaft and affixed thereto for rotation therewith.
